(19) United States
(12) Patent Application Publication
(10) Pub. No.: US 2019/0102778 A1
(43) Pub. Date: Apr. 4, 2019

(54) SECURE ONLINE TRANSACTION SYSTEM AND METHOD THEREFOR

(71) Applicant: ENMAX ENCOMPASS INC., Calgary (CA)

(72) Inventor: Tomas Lebovic, Calgary (CA)

(73) Assignee: ENMAX ENCOMPASS INC., Calgary (CA)

(21) Appl. No.: 15/721,009

(22) Filed: Sep. 29, 2017

(51) Int. Cl. G06Q 20/40

(52) U.S. Cl. CPC G06Q 20/401; G06Q 2220/00

(57) ABSTRACT

A network system for completing a transaction session includes a merchant subsystem storing a first data set unrelated to the transaction and a secure subsystem storing second data related to the transaction. The second data includes at least one or more user interface (UI) components and one or more client-side application programs. The network system acts for sending the first data set from the merchant subsystem to a client computing device; sending the second data from the secure subsystem to the client computing device for displaying the one or more UI components on the client computing device; executing the one or more client-side application programs on the client computing device for collecting transaction-related data from the user of the client computing device; and sending collected data to a transaction processing subsystem for completing the transaction session.

### FIELD OF THE DISCLOSURE

The present disclosure relates generally to a secure online transaction system and a related method, and in particular to a secure online transaction system in compliance with Payment Card Industry (PCI) standards and a method therefor.

### BACKGROUND

With the growth of the Internet, online payment has been widely used. For example, a client or customer executes a web browser application program on a computing device to visit a merchant website via the Internet. The web site presents a list of products. The client may select one or more products to purchase, and add the selected products into a virtual “shopping cart”. To complete the purchase of the selected products, the client may go through a checkout process by providing electronic payment information such as a credit card number, the cardholder's name and address, the credit card's expiration date, and the credit card's Card Verification Value (CVV). A payment processing server processes the payment information and establishes a transaction to deduct a monetary credit from the credit card and transfer the ownership of the selected products to the client. The purchase is then completed. In some systems, the client may also use other types of payment information such as debit cards, gift cards, PAYPAL® (PAY PAL is a registered trademark of PayPal Inc., San Jose, Calif., USA), and the like, to establish the transaction.

Due to the sensitivity of the transaction-related information, enhanced security measurements are usually required to protect the transaction-related information from being manipulated, tampered, or otherwise stolen. Various security standards have been established. Among these standards, the Payment Card Industry (PCI) standards are often required in the credit card industry. However, these security standards apply significant burden to merchant's hardware and software systems for compliance.

To alleviate the burden of implementing enhanced security measurements, many merchants use third-party payment processing systems for establishing transactions. Generally, when a client starts a transaction session by entering the checkout process, the client is redirected to a third-party payment processing system to provide the transaction-related information for establishing the transaction. After the transaction session is completed, the client is redirected back to the merchant website to receive a confirmation of established transaction and other information such as product delivery information.

As the merchant website and the payment processing system are managed and maintained by different entities, the above-described redirection method implies that the merchant has no control of the user experience in the transaction process, thereby causing various disadvantages to the merchant such as lack of control over the look and feel of the user interface during the transaction process, difficulties in integrating the transaction process with other functionalities of the merchant system, and the like.

Other online transaction methods are also available. For example, in some prior-art systems, encryption functions are provided for downloading to the client computing device to encrypt the transaction-related information or data. However, the merchant websites in these systems still process some transaction-related data. Under the rigorous requirements of the PCI standards, any computer system, network, and software involved in payment processing have to be compliant with the PCI standards, thereby still imposing significant burden to the merchant websites.

### SUMMARY

According to one aspect, there is disclosed an online transaction system. The online transaction system comprises a merchant subsystem and a secure subsystem in communication with one or more transaction processing subsystems. Each subsystem may comprise one or more server computers. The merchant subsystem and the secure subsystem may be managed and maintained by a same entity. The one or more transaction processing subsystems are managed by a different or otherwise separate entity.

The merchant subsystem provides online shopping services to a client computer or mobile device running a browser or a payment app. The merchant subsystem does not host nor process any transaction-related data, and therefore may not need to be in compliance with the PCI standards.

On the other hand, the secure subsystem is in compliance with the PCI Data Security Standard (DSS) and hosts transaction-related programs such as client-side JavaScript encryption programs that may he executed on a client computing device, and transaction-related user-interface (UI) components that may be displayed on the client computing device. At least one or more users of the merchant subsystem have the rights to access the secure subsystem and modify the content hosted thereon.

A client may launch a browser or a payment app on a client computer or a client mobile device to access the merchant subsystem and select one or more products and/or services (collectively denoted as products) listed thereon. The client may purchase the selected products by starting an online transaction session. A transaction page is then provided to the client device. The transaction page may comprise non-transaction-related data obtained from the merchant subsystem and transaction-related data obtained from the secure subsystem, for example, transaction-related UI components and one or more client-side programs such as a client-side JavaScript encryption program.

The client may use the transaction page to provide transaction-related information, for example payment information such as a credit card number, billing information, expiration date, CVV, and the like. A client-side encryption program downloaded from the secure subsystem, encrypts the transaction-related information, selects a service provider such as a transaction processing subsystem, generates a validation “fingerprint”, and sends the encrypted transaction-related information to the selected service provider without going through the merchant subsystem.

The service provider uses the information received from the client device to establish a transaction. After the transaction is completed, the secure subsystem uses the verification fingerprint to verify the integrity of the transaction in real-time.

According to another aspect, there is provided a network system for completing a transaction session. The system comprises a merchant subsystem storing a first data set unrelated to said transaction, and a secure subsystem storing a second data set related to said transaction. During the transaction, said network system acts for starting the transaction session; sending at least said first data set from the merchant subsystem to a client computing device, sending at least said second data set from the secure subsystem to the client computing device; receiving at least a third data set related to said transaction, and completing the transaction session using at least said third data set such that the merchant subsystem is excluded from accessing said second and third data sets.

In some embodiments, said completing the transaction session using at least said third data set comprises sending at least said third data set to a transaction processing subsystem for completing the transaction session.

In some embodiments, said sending at least said third data set to the transaction processing subsystem comprises selecting the transaction processing subsystem from a plurality of transaction processing subsystems, and sending at least said third data set to the selected transaction processing subsystem for completing the transaction session.

In some embodiments, said first data set comprises a template unrelated to said. transaction, said second data set comprises user-interface (UI) components and one or more client-side application programs, and said third data set comprises payment related data.

In some embodiments, during the transaction, said network system further acts for executing the one or more client-side application programs on the client computing device to encrypt said third data set, and said sending at least said third data set to the transaction processing subsystem comprises sending at least said encrypted third data set to the transaction processing subsystem for completing the transaction session.

In some embodiments, said secure subsystem is in compliance with one or more enhanced security standards.

In some embodiments, said one or more enhanced security standards comprises the PCI standards, and wherein said merchant subsystem is uncompliant with said PCI standards.

In some embodiments, during said transaction, said secure subsystem generates a unique fingerprint for said transaction by using characteristics of the transaction session unrelated to the content of the transaction.

According to another aspect, there is provided a network system for completing a transaction session. The system comprises a merchant subsystem storing a first data set unrelated to said transaction; and a secure subsystem storing a second data set related to said transaction. Said second data set comprises at least one or more UI components and one or more client-side application programs. During said transaction, said network system acts for starting the transaction session, sending at least said first data set from the merchant subsystem to a client computing device, sending at least said second data set from the secure subsystem to the client computing device for merging with said first data set and displaying at least the one or more UI components on said client computing device, collecting at least a third data set related to said transaction from the user of the client computing device, executing said one or more client-side application programs on said client computing device for encrypting the third data set, and sending at least said encrypted third data set to a transaction processing subsystem for completing the transaction session,

In some embodiments, during said transaction, said network system further acts for determining the transaction processing subsystem from a plurality of transaction processing subsystems.

In some embodiments, said first data set comprises a template unrelated to said transaction, and said third data set comprises payment related data.

In some embodiments, said secure subsystem is in compliance with one or more enhanced security standards.

In some embodiments, said one or more enhanced security standards comprises the PCI standards, and wherein said merchant subsystem is uncompliant with said PCI standards.

In some embodiments, during said transaction, said secure subsystem generates a unique fingerprint for said transaction by using characteristics of the transaction session unrelated to the content of the transaction.

According to another aspect, there is provided a method for completing a transaction session. The method comprises starting the transaction session, sending at least a first data set from a merchant subsystem to a client computing device, said first data set unrelated to said transaction, sending at least a second data set from a secure subsystem to the client computing device, receiving at least a third data set related to said transaction, and completing the transaction session using at least said third data set, such that the merchant subsystem is excluded from accessing said second and third data sets.

In some embodiments, said completing the transaction session using at least said third data set comprises sending at least said third data set to a transaction processing subsystem for completing the transaction session.

In some embodiments, said sending at least said third data set to the transaction processing subsystem comprises selecting the transaction processing subsystem from a plurality of transaction processing subsystems, and sending at least said third data set to the selected transaction processing subsystem for completing the transaction session.

In some embodiments, said first data set comprises a template unrelated to said transaction, said second data set comprises UI components and one or more client-side application programs, and said third data set comprises payment related data.

In some embodiments, the method further comprises displaying at least said received one or more UI components on the client computing device,

In some embodiments, the method further comprises executing the one or more client-side application programs on the client computing device to encrypt said third data set, and said sending at least said third data set to the transaction processing subsystem comprises sending at least said encrypted third data set to the transaction processing subsystem for completing the transaction session.

In some embodiments, said secure subsystem is in compliance with one or more enhanced security standards.

In some embodiments, said one or more enhanced security standards comprises PCI standards, and wherein said merchant subsystem is uncompliant with said PCI standards.

In some embodiments, the method further comprises generating a unique fingerprint for said transaction by using characteristics of the transaction session unrelated to the content of the transaction.

According to another aspect, there is provided a method for completing a transaction session. The method comprises starting the transaction session, sending at least a first data set from a merchant subsystem to a client computing device, said first data set unrelated to said transaction, sending at least one or more UI components and one or more client-side application programs from a secure subsystem to the client computing device, displaying at least said received one or more UI components on the client computing device, collecting a transaction-related data set at the client computing device from a user thereof, executing the one or more client-side application programs on the client computing device to encrypt said collected transaction-related data set, and sending the encrypted transaction-related data set to a transaction processing subsystem for completing the transaction session.

In some embodiments, the method further comprises selecting the transaction processing subsystem from a plurality of transaction processing subsystems.

In some embodiments, said first data set comprises a template unrelated to said transaction, and said transaction-related data set comprises payment related data.

In some embodiments, said secure subsystem is in compliance with one or more enhanced security standards.

In some embodiments, said one or more enhanced security standards comprises PCI standards, and wherein said merchant subsystem is uncompliant with said PCI standards.

In some embodiments, the method further comprises generating a unique fingerprint for said transaction by using characteristics of the transaction session unrelated to the content of the transaction.

According to another aspect, there is provided a method for completing a transaction session. The method comprises receiving at least a first data set from a merchant subsystem, said first data set unrelated to said transaction, receiving at least one or more UI components and one or more client-side application programs from a secure subsystem, displaying at least said one or more UI components, collecting at least a transaction-related data set from a client; executing said one or more client-side application programs to encrypt said collected transaction-related data set, and sending said encrypted transaction-related data set to a transaction processing subsystem for completing the transaction session.

In some embodiments, the method further comprises selecting the transaction processing subsystem from a plurality of transaction processing subsystems.

In some embodiments, said first data set comprises a template unrelated to said transaction, and said transaction-related data set comprises payment related data.

In some embodiments, said secure subsystem is in compliance with one or more enhanced security standards,

In some embodiments, said one or more enhanced security standards comprises PCI standards, and wherein said merchant subsystem is uncompliant with said PCI standards.

In some embodiments, the method further comprises generating a unique fingerprint for said transaction by using characteristics of the transaction session unrelated to the content of the transaction.

According to another aspect, there is provided one or more non-transitory storage devices storing computer-executable instructions for completing a transaction session. The instructions, when executed, cause a processor to perform actions comprising starting the transaction session, sending at least a first data set from a merchant subsystem to a client computing device, said first data set unrelated to said transaction, sending at least one or more UI components and one or more client-side application programs from a secure subsystem to the client computing device, displaying said received one or more UI components on the client computing device, collecting a transaction-related data set at the client computing device from a user thereof, executing the one or more client-side application programs on the client computing device to encrypt said collected transaction-related data set, and sending the encrypted transaction-related data set to a transaction processing subsystem for completing the transaction session.

In some embodiments, the instructions, when executed, cause a processor to farther perform actions comprising selecting the transaction processing subsystem from a plurality of transaction processing subsystems.

In some embodiments, said first data set comprises a template unrelated to said transaction, and said transaction-related data set comprises payment related data.

In some embodiments, said secure subsystem is in compliance with one or more enhanced security standards.

In some embodiments, said one or more enhanced security standards comprises PCI standards, and wherein said merchant subsystem is uncompliant with said PCI standards.

In some embodiments, the instructions, when executed, cause a processor to further perform actions comprising generating a unique fingerprint for said transaction by using characteristics of the transaction session unrelated to the content of the transaction.

According to another aspect, there is provided one or more non-transitory storage devices storing computer-executable instructions for completing a transaction session. The instructions, when executed, cause a processor to perform actions comprising receiving at least a first data set from a merchant subsystem, said first data set unrelated to said transaction, receiving at least one or more UI components and one or more client-side application programs from a secure subsystem, displaying said one or more UI components, collecting a transaction-related data set from a client, executing said one or more client-side application programs to encrypt said collected transaction-related data set, and sending the encrypted transaction-related data set to a transaction processing subsystem for completing the transaction session.

In some embodiments, the instructions, when executed, cause a processor to further perform actions comprising selecting the transaction processing subsystem from a plurality of transaction processing subsystems.

In some embodiments, said first data set comprises a template unrelated to said transaction, and said transaction-related data set comprises payment related data.

In some embodiments, said secure subsystem is in compliance with one or more enhanced security standards.

In some embodiments, said one or more enhanced security standards comprises PCI standards, and wherein said merchant subsystem is uncompliant with said PCI standards.

In some embodiments, the instructions, when executed, cause a processor to further perform actions comprising generating a unique fingerprint for said transaction by using characteristics of the transaction session unrelated to the content of the transaction.

### BRIEF DESCRIPTION OF THE DRAWINGS

FIG. 1 is a schematic diagram of a network system, according to some embodiments of the present disclosure;

FIG. 2 is a schematic diagram showing a simplified hardware structure of a computing device of the network system shown in FIG. 1;

FIG. 3 a schematic diagram showing a simplified software architecture of a computing device of the network system shown in FIG. 1.

FIG. 4 is a schematic diagram showing a simplified software architecture of the network system shown in FIG. 1;

FIG. 5 is a schematic diagram showing a function structure of the network system shown in FIG. 1:

FIG. 6 is a flowchart showing the steps of completing an online transaction in the network system shown in FIG. 1;

FIG. 7A shows a piece of code executed by a client device of the network system shown in FIG. 1 for application initialization;

FIG. 7B shows a piece of code of a user-interface (UI) fragment controller executed by a client device of the network system shown in FIG. 1 for payment gateway extension;

FIG. 8 shows a piece of Hypertext Markup Language (HTML) code of a UI fragment of the network system shown in FIG. 1; and

FIGS. 9A to 9D show the UI of an example of a payment process.

### DETAILED DESCRIPTION

Embodiments disclosed herein provide an online transaction system and method in compliance with relevant security standards such as the Payment Card Industry (PCI) standards. In some embodiments, the online transaction system comprises a merchant subsystem and a secure subsystem in communication and collaborating with one or more transaction processing subsystems. In these embodiments, the one or more transaction processing subsystems are not a part of the network system.

The merchant subsystem generally comprises a front portion and a back portion. The front portion is the portion of the merchant subsystem that is accessible by any users such as clients or customers. For example, the front portion may be an interface of a merchant website accessible by a browser application program running on a client device or alternatively, an interface downloadable to a mobile app running on a client device. The back portion is the portion of the merchant subsystem that is not directly accessible by unauthorized users (clients/customers) such as server-side application programs and databases with restricted-access right settings. The merchant subsystem is not necessarily in compliance with the PCI standards. During a transaction session, the merchant subsystem provides non-transaction-related data such as a transaction template with tags to a client device.

The secure subsystem is implemented with enhanced security measurements and is in compliance with the PCI standards. The secure subsystem stores transaction-related data such as transaction-related user-interface (UI) fragments, including transaction-related UI components to be displayed on client devices and application programs to be executed on client devices. During a transaction session, the secure subsystem provides transaction-related data such as input fields for payment information and payment information processing application programs to the client device for merging with the transaction template.

The merchant subsystem and the secure subsystem are managed and maintained by a same entity and may be configurable and/or modifiable by a same group of users. On the other hand, the transaction processing subsystem is managed and maintained by a different entity and the users of the transaction processing subsystem have no right to configure or modify the merchant and secure subsystems. In some embodiments, the users of the transaction processing subsystem do not have the right to access the back portion of the merchant and secure subsystems.

In some embodiments, the online transaction system disclosed herein can inject a native UI fragment from the secure subsystem into the web and/or mobile views on the client computing device. A transaction template with tags is used for merging the fragment thereinto wherein the tags indicate where and how the UI fragment shall be embedded into the template for generating the web/mobile views at runtime.

In some embodiments, the online transaction system disclosed herein provides a real-time service-provider selection mechanism for selecting in real-time during the transaction session, a best-fit service provider such as a payment gateway or a transaction processing subsystem that fulfills the client's request. In particular, upon submission of transaction-related data, the UI fragment collaborates with the secure subsystem to select a transaction processing subsystem based on suitable rules including business rules, user and/or session data, customer information, and/or the like. For example, the rules for selecting a transaction processing subsystem may be based on factors such as best interest rate, availability, transaction type, dollar amount to pay, type of credit card to be used, lowest service fees, and the like. The information of selected transaction processing subsystem is packaged as an interaction service model object for sending with the UI fragment to the client computing device. The real-time service-provider selection mechanism disclosed herein adds security benefit of cloaking the service provider from the user until a transaction session starts.

In some embodiments, the online transaction system disclosed herein generates a unique “fingerprint” for each transaction. Unlike prior-art fingerprints based on credit card data and/or tokenized data, the fingerprint disclosed herein is generated based on unique characteristics of the transaction session such as the network connection, transaction, selected service provider, and other relevant metadata. This unique fingerprint is stored in the system and is associated with the transaction.

By using the unique fingerprint of a transaction session, the online transaction system disclosed herein can validate the completed transaction in real-time to ensure that the transaction payload was not manipulated or otherwise tampered by the client or a third party.

In some embodiments, the online transaction system disclosed herein also provides secure back-channel data exchange between enterprise business support systems (BSS) or operations support systems (OSS) and service providers without either party knowing about the other. The back channel communication may also use the above-described method for generating unique “fingerprint” for batch processes including but not limited to recurring billing, fraud management, settlement, and the like.

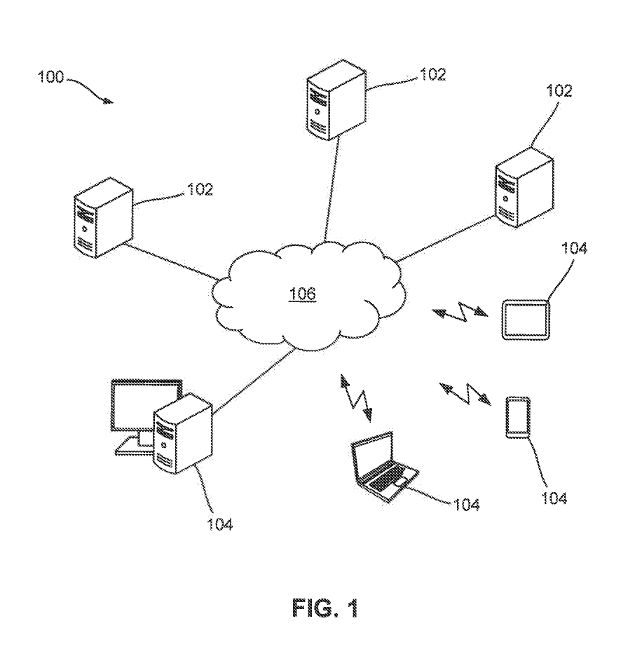

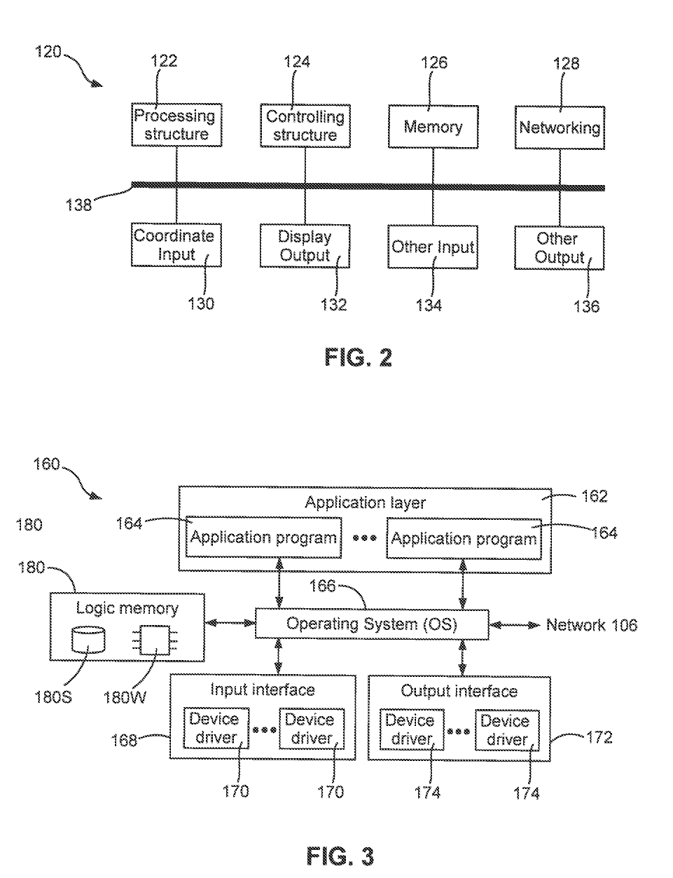

Turning now to FIG. 1, a network system in the form of an online transaction system is shown and is generally identified using reference numeral 100. In this embodiment, the network system 100 comprises a plurality of server computers 102 and one or more client computing devices 104 such as desktop computers, laptop computers, tablets, smartphones, Personal Digital Assistants (PDAs) and the like, interconnected by a network 106 such as the Internet, a local area network (LAN), a wide area network (WAN), or the like, via suitable wired and/or wireless networking connections.

The server computer 102 may be a computing device specially designed for performing server functions or alternatively, a general-purpose computing device acting as a server computer. The client computing devices 104 may be general-purpose computing devices such as desktop computers and laptop computers and/or specialized computing devices such as smartphones and tablets.

FIG. 3 shows the hardware structure 120 of a computing device which may be the server computer 102 or the client computing device 104. The computing device 102 or 104 comprises a processing structure 122, a controlling structure 124, a memory or storage 126, a networking interface 128, a coordinate input 130, a display output 132, and other input and output modules 134 and 136, all functionally interconnected by a system bus 138.

The processing structure 122 may be one or more single-core or multiple-core computing processors such as INTEL microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ^{ARM}® microprocessors (ARM is a registered trademark of Arm Ltd., Cambridge, UK), or the like.

The controlling structure 124 comprises a plurality of controllers such as graphic controllers, input/output chipsets, and the like, for coordinating operations of various hardware components and modules of the computing device 102 or 104.

The memory 126 comprises a plurality of memory units accessible by the processing structure 122 and the controlling structure 124 for reading and/or storing data including input data and data generated by the processing structure 122 and the controlling structure 124. The memory 126 may be volatile and/or non-volatile, non-removable or removable memory such as RAM, ROM, EEPROM, solid-state memory, hard drives, CD, DVD, flash memory, or the like. In use, the memory 126 is generally partitioned into a plurality of portions for different use purposes. For example, a portion of the memory 126 denoted as storage memory herein, may be used for long-term data storing e.g., storing files or databases. Another portion of the memory 126 may be used as the system memory for storing data during processing denoted as working memory herein.

The networking interface 128 comprises one or more networking modules for connecting to other computing devices or networks via wired or wireless connections such as Ethernet, WI-FI® (WI-FI is a registered trademark of the City of Atlanta DBA Hartsfield-Jackson Atlanta International Airport Municipal Corp., Atlanta, Ga., USA), BLUETOOTH® (BLUETOOTH is a registered trademark of Bluetooth Sig Inc, Kirkland, Wash., USA), ZIGBEE® (ZIGBEE is a registered trademark of ZigBee Alliance Corp., San Ramon, Calif., USA), 3G and 4G wireless mobile telecommunications technologies, and the like. In some embodiments, parallel ports, serial ports, USB connections, optical connections, or the like may also be used for connecting other computing devices or networks, although they are usually considered as input/output interfaces for connecting input/output devices.

The coordinate input 130 comprises one or more input modules for one or more users to input coordinate data. Examples of the coordinate input 130 may include but not limited to touch-sensitive screen, touch-sensitive whiteboard, trackball, computer mouse, touch-pad, or other human interface devices (HID) and the like. The coordinate input 130 may be a physically integrated part of the computing device 102 or 104 (such as the touch-pad of a laptop computer or the touch-sensitive screen of a tablet), or may be a display device physically separate from, but functionally coupled to, other components of the computing device 102 or 104 (such as a computer mouse). In some embodiments, the coordinate input 130 may be integrated with the display output 132 to form a touch-sensitive screen or touch-sensitive whiteboard.

The display output 132 comprises one or more display modules for displaying images and videos, such as monitors, LCD displays, LED displays, projectors, and the like. The display output 132 may be a physically integrated part of the computing device 102 or 104 (such as the display of a laptop computer or a tablet), or may be a display device physically separate from but functionally coupled to other components of the computing device 102 or 104 such as a monitor of a desktop computer).

The computing device 102 or 104 may also comprise other inputs 134 such as keyboards, microphones, scanners, and the like. The computing device 102 or 104 may further comprise other outputs 136 such as speakers, printers, and the like.

The system bus 138 interconnects various components 122 to 136 enabling them to transmit and receive data and control signals to/from each other.

FIG. 3 shows a simplified software architecture 160 of the computing device 102 or 104. The software architecture 160 comprises an application layer 162, an operating system 166, an input interface 168, an output interface 172, and logic memory 180. The application layer 162 comprises one or more application programs 164 executed by or run by the processing structure 122 for performing various tasks. The operating system 166 manages various hardware components of the computing device 102 or 104 via the input interface 168 and the output interface 172, manages logic memory 180, and manages and supports the application programs 164. The operating system 166 is also in communication with other computing devices (not shown) via the network 106 to allow application programs 164 to communicate with those running on other computing devices. As those skilled in the art will appreciate, the operating system 166 may be any suitable operating system such as MICROSOFT® WINDOWS® (MCROSOFT and WINDOWS are registered trademarks of the Microsoft Corp, Redmond, Wash., US), APPLE® OS X, APPLE® iOS (APPLE is a registered trademark of Apple Inc., Cupertino, Calif., USA), Linux, ANDROID® (AND IOD is a registered trademark of Google Inc., Mountain View, Calif., USA), or the like, The computing devices 102 and 104 of the network system 100 may all have the same operating system, or may have different operating systems.

The input interface 168 comprises one or more input device drivers 170 for communicating with respective input devices including the coordinate input 130. The output interface 172 comprises one or more output device drivers 174 managed by the operating system 166 for communicating with respective output devices including the display output 132. Input data received from the input devices via the input interface 168 is sent to the application layer 162, and is processed by one or more client-side application programs 164 (also denoted as “application programs” for ease of description). The output generated by the application programs 164 is sent to respective output devices via the output interface 172.

The logical memory 180 is a logical mapping of the physical memory 126 for facilitating the application programs 164 to access. In this embodiment, the logical memory 180 comprises a storage memory area (180S) that is usually mapped to non-volatile physical memory, such as hard disks, solid state disks, flash drives and the like, for generally long-term storing data therein. The logical memory 180 also comprises a working memory area (180W) that is generally mapped to high-speed, and in some implementations volatile, physical memory such as RAM, for application programs 164 to generally temporarily store data during program execution. For example, an application program 164 may load data from the storage memory area 180S into the working memory area 180W, and may store data generated during its execution into the working memory area 180W. The application program 164 may also store some data into the storage memory area 1805 as required or in response to a user's command.

In a server computer 102, the application layer 162 generally comprises one or more server-side application programs 164 which provide server functions for managing network communication with client computing devices 104 and facilitating collaboration between the server computer 102 and the client computing devices 104. Herein, the term “server” may refer to a server computer 102 from a hardware point of view, or a logical server from a software point of view, depending on the context.

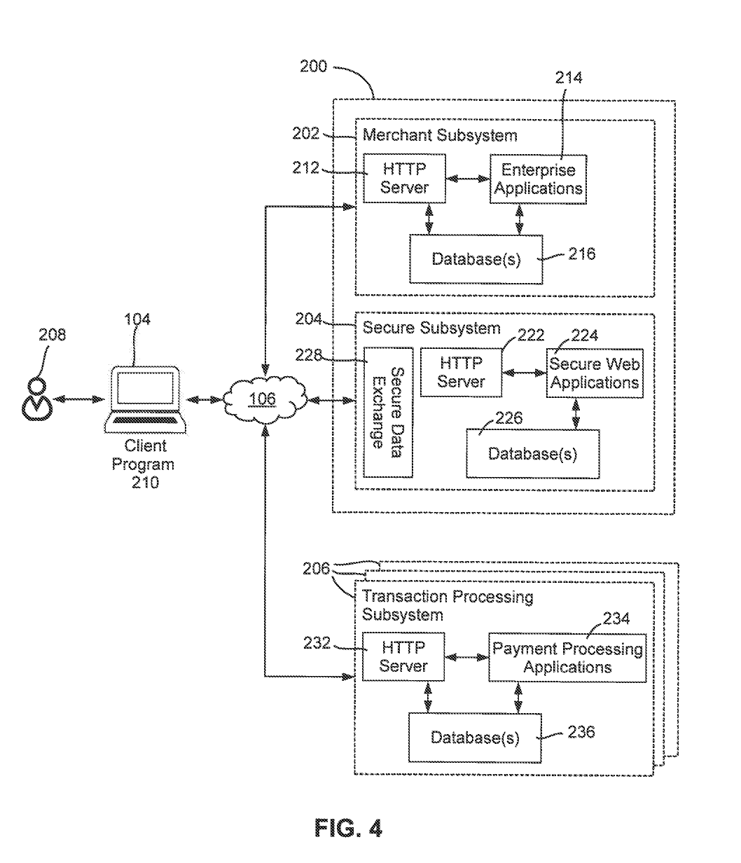

FIG. 4 is a schematic diagram showing a simplified software architecture 200 of the network system 100. As shown, the servers 102 in these embodiments are partitioned into a merchant subsystem 202 and a secure subsystem 204 in communication with a plurality of transaction processing subsystems 206 via the network 106. In these embodiments, the transaction processing subsystems 206 are not a part of the network system 100.

The merchant subsystem 202 comprises a merchant application server 212, one or more server-side enterprise applications 214, and one or more enterprise databases 216. In these embodiments, the merchant application server 212 is a HTTP server interacting with one or more client-side application programs 210 using the Hypertext Transfer Protocol (HTTP) and/or Hyper Text Transfer Protocol Secure (HTTPS) protocols. Of course, other suitable protocols may also be used.

The one or more enterprise applications 214 comprises server-side application programs for forming a merchant website and necessary functionalities thereof for providing products to customers. The one or more enterprise databases 216 provide data for the merchant website, and also stores merchant and customer data such as product names, product specifications, product images, product prices, product inventories, customer names, customer addresses, shipping addresses, and the like. Generally, the customer data stored in the one or more enterprise databases 216 are less-sensitive, non-transaction-related data (described later) and may not require enhanced security.

As those skilled in the art will appreciate, the term “product” used herein has a broad meaning of any suitable merchandise that a client may pay for, such as a physical product or goods, an intellectual product such as a software program, a service, and the like.

The secure subsystem 204 comprises a secure server 222 such as a HTTP server, one or more server-side secure applications 224 such as one or more server-side secure web applications and one or more secure databases 226. As will be described in more detail later, the secure subsystem 204 is supplementary to the merchant subsystem 202 and provides sensitive, transaction-related data and programs (described later) to the client-side application program 210 as needed. Therefore, the secure subsystem 204 is implemented with enhanced security measurements such as the enhanced security required by PCI standards. As a part of the enhanced security measurements, communications coming in and going out of the secure subsystem 204 are through a secure data exchange interface 228.

Herein, a transaction refers to a process or a record of exchanging a credit with the ownership of one or more products and/or services. A transaction may also refer to a process or a record of exchanging credit card data with no immediate exchange of credit wherein the exchange of credit can occur at a later time. Examples of such transactions include recurring transactions, batch payments, and the like. A transaction session refers to an instance of the transaction process that may be initiated by a client or customer, for example such as by starting a checkout process, and completed after a credit from the client has been exchanged with the ownership of a set of products from a merchant. However, the completion of a transaction session as disclosed herein does not necessarily mean that the set of products have been actually delivered to the client.

The transaction-related data and programs refer to data related to a transaction and programs processing such data. For example, in some embodiments, the transaction-related data and programs may comprise a customer's payment information such as a credit card number, a credit card's Card Verification Value (CVV), an input field for inputting a credit card number, a program for processing a credit card number, and the like. Transaction-related data may be partitioned into user-provided transaction-related data provided by a client (such as a credit card number) and system-hosted transaction-related data provided the online transaction system 100 (such as an input field for inputting a credit card number). Transaction-related data and programs require enhanced security measurements under relevant standards such as PCI standards.

On the other hand, non-transaction-related data and programs refers to data not directly related to any transaction and programs processing such data. For example, in some embodiments, the non-transaction-related data and programs may comprise a product name, specification, price, an input field for inputting the quantity of products that a customer wish to buy, a program listing one or more products, and the like. Non-transaction-related data may not necessarily require enhanced security measurements. Those skilled in the art will appreciate that in various embodiments and depending on the use scenarios, the definition of transaction-related and non-transaction-related data may vary, and some non-transaction-related data in some embodiments may be considered as transaction-related data in some other embodiments.

Each transaction processing subsystem 206 comprises a payment server 232 such as a HTTP server, one or more payment processing applications 234 for processing payment data and completing online transactions, and one or more payment databases 236 for storing payment related data. The transaction processing subsystem 206 is implemented with enhanced security measurements.

Under the principle of Separation of Duties also known as segregation of duties (SoD) during the development and life cycle of the network system 100, each subsystem 202, 204, 206 comprises one or more system-management user accounts having the rights of modifying and configuring at least a portion of the subsystem. Such system-management user accounts may include for example, one or more administrator accounts, one or more database maintenance user accounts, one or more developer accounts, one or more release manager accounts, one or more build manager accounts, and the like. Different system-management user accounts may have different system-management rights. For example, an administrator account may have necessary rights for maintaining and configuring the subsystem such as modifying the configuration of the subsystem, modifying the configuration of the server, modifying the configuration of the server-side application programs, and the like. A database maintenance user account may have necessary rights for maintaining and configuring the databases, such as modifying the configuration of the databases, modifying the content (such as the records, indices, and the like) of the databases, and the like. A developer account may have the rights for maintaining, configuring and upgrading the server-side application programs such as modifying the configuration of the server-side application programs, upgrading the server-side application programs to newer versions, installing the server-side application programs, removing obsolete server-side application programs, and the like.

In these embodiments, the merchant subsystem 202 and the secure subsystem 204 may be managed, maintained and/or operated by a same entity and/or a same group of system-management users. Therefore, a system-management user of the merchant subsystem 202 may also be a system-management user of the secure subsystem 204. However, the transaction processing subsystems 206 are separated from the merchant subsystem 202 and the secure subsystem 204, and are managed, maintained and/or operated by a different entity and/or a different group of system-management users. Therefore, a system-management user of a transaction processing subsystem 206 does not have any system-management rights in the merchant subsystem 202 nor in the secure subsystem 204.

As described above, the merchant subsystem 202 forms a merchant website. A customer or client 208 uses a client computing device 104 running a client-side application program 210, such as a web browser application or a mobile app designed for the merchant's business, to access the merchant server 212. The merchant server 212 collaborates with the enterprise applications 214 and the merchant databases 216 to provide a list of products to the client 208 via the client-side application program 210. The client 208 may select one or more products and buy the selected products via an online transaction process that involves the secure subsystem 204 and one of the transaction processing subsystems 206.

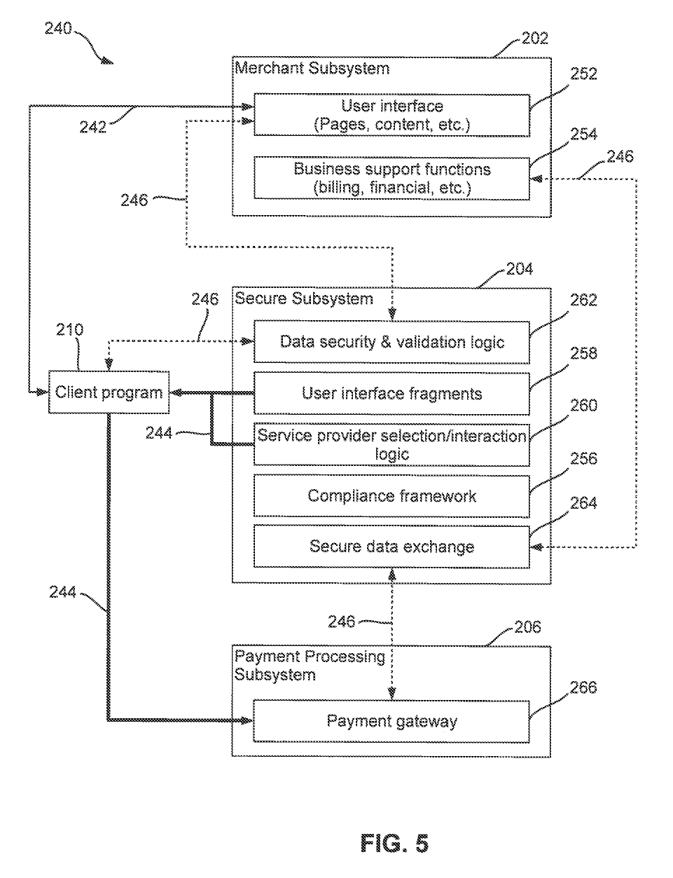

FIG. 5 illustrates a function structure 240 of the network system 100, showing the function modules of the merchant subsystem 202 and the secure subsystem 204. The function module of the transaction processing subsystem 206 is also shown. FIG. 5 further shows the transaction-related data exchanged therebetween wherein the thin solid line 242 represents exchange of non-transaction-related data, the thick solid lines 244 represent exchange of transaction-related data, and the broken lines 246 represents instructions and responses between subsystems 202, 204 and 206.

As shown, the merchant subsystem 202 comprises user interface data 242 and business support functions 254 such as billing, financial functions, and the like. The user-interface data in the merchant system 202 is generally non-transaction-related data such as webpages, transaction templates, and merchandise contents such as product lists, product prices, and the like, which is sent to the client program 210 for display on the client computing device 104.

The secure subsystem 204 comprises a compliance framework 256, one or more UI fragment 258, a service provider selection and interaction logic module 260, a data security and validation logic module 262, and a secure data exchange module 264. The compliance framework 256 ensures that the secure subsystem 204 is in compliance with required security standards such as the PCI standards. The one or more UI fragment 258 including UI components such as Hypertext Markup Language (HTML) components, files and the like, and runtime programs such as JavaScript or other runtime programs, to be sent to the client computing device 104 for execution thereon. The runtime program comprises a UI fragment controller program for controlling the actions of the UI components. The UI fragments 258 stored in the secure subsystem 204 are those categorized as transaction-related data and requiring enhanced security measurements under the PCI standards.

The service provider selection and interaction logic module 260 selects a suitable one of the transaction processing subsystems 206, and notifies the client computing device 104 regarding the selected transaction processing subsystem 206. The data security and validation logic module 262 creates a unique “fingerprint” for the transaction session and validates the completed transaction in real-time to ensure that the transaction payload was not manipulated or otherwise tampered by the client program 210 or a third party.

The secure data exchange module 264 collaborates with a payment gateway 266 of the transaction processing subsystem 206 and the business support functions 254 of the merchant subsystem 202 with enhanced security in communication therebetween to record the billing and financing information of the transaction. The secure data exchange module 264 facilitates batch data exchange or any non-real-time data exchange that does not require user interaction such as reports, transaction history, recurring payments, and the like.

When the client program 210 instructs the merchant subsystem 202 to start an online transaction session for example, when a “checkout” button was pressed (described in more detail later), the merchant subsystem 202 sends non-transaction-related data such as a transaction template to the client computing device 104. The secure subsystem 204 sends transaction-related UI fragment and programs to the client computing device 104 for merging with the non-transaction-related transaction template obtained from the merchant subsystem 202. A unique “fingerprint” is also generated for the transaction session, and a transaction processing subsystem 206 is selected based on suitable criteria and/or business rules such as best interest rate, availability, transaction type, and the like. The information of the selected transaction processing subsystem 206 is sent to the client computing device 104.

The client computing device 104 then receives user input for the completing the information needed for the online transaction, and sends the transaction-related information to the selected transaction processing subsystem 206 for establishing the transaction. The secure subsystem 204 monitors and validates the entire process of the online transaction, and collaborates with the merchant subsystem 202 and the selected transaction processing subsystem 206 to record the transaction. During the process of the online transaction, the client program 210 sends transaction-related data directly to the transaction processing subsystem 206, therefore bypassing the less-secure merchant subsystem 202. On the other hand, the secure subsystem 204 provides the connection specific services.

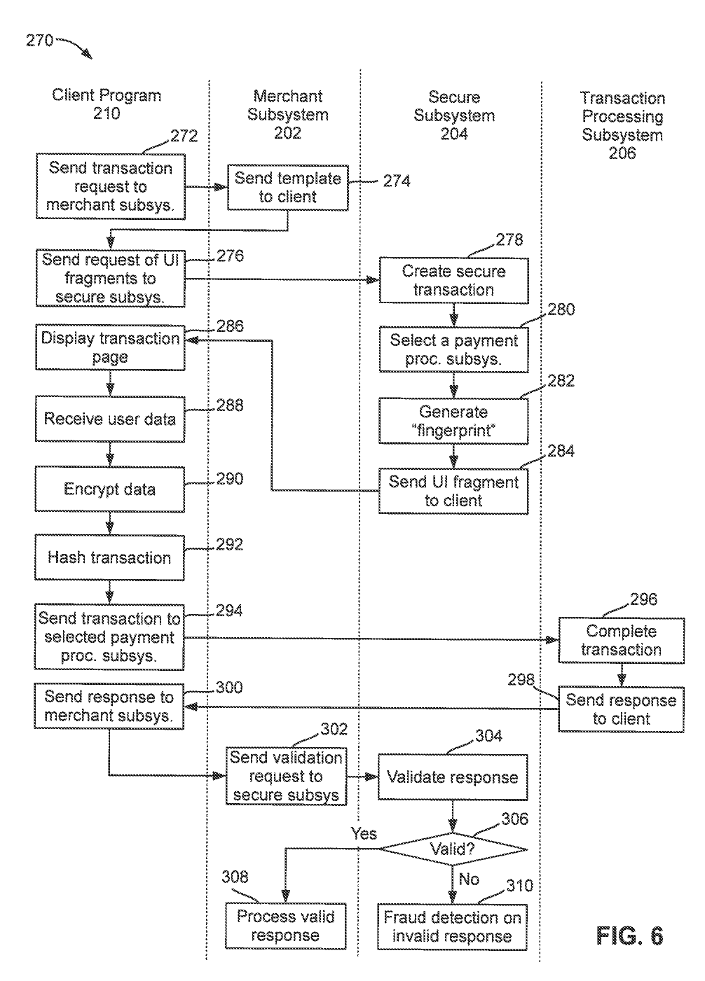

FIG. 6 is a flowchart showing the steps of an online transaction process 270 in the network system 100. As described before, a client may operate a client computing device 104 executing a client application program 210 such as a web browser to access the merchant subsystem 202 for obtaining a list of products. The client may select one or more products for example by adding the products into a virtual “shopping cart”. The client may then click, or press a “checkout” button to start an online transaction process.

As shown in FIG. 6, after the client starts the transaction process, the client application program 210 sends a transaction request to the merchant subsystem 202 (step 272). The merchant subsystem 202 receives the transaction request and sends a transaction template to the client application 210 (step 274). In these embodiments, the transaction template is a webpage template having one or more tags and a page-initialization JAVASCRIPT® program (JAVASCRIPT is a registered trademark of Oracle America Inc., Redwood Shores, Calif., USA).

At step 276, the page-initialization JAVASCRIPT® program is executed for example, by the client application program 210. The page-initialization JAVASCRIPT® program analyzes the tags in the webpage template and sends request of UI fragment to the secure subsystem 204.

After receiving the request of UI fragment, the secure subsystem 204 creates a secure transaction session (step 278). At step 280, the secure subsystem 204 selects a transaction processing subsystem from a plurality of available transaction processing subsystems 206 based on suitable criteria and/or business rules such as best interest rate, availability, transaction type, and the like. The information of the selected transaction processing subsystem 206 is packaged as an interaction service model object for sending to the client device 104.

In some embodiments, the secure subsystem 204 stores relevant information (such as interest rate, available terms, fees, and the like) of each transaction processing subsystem 206. Then at step 280 of each transaction session, the secure subsystem 204 uses the stored information of the transaction processing subsystems 206 to select one that best fits the client's request. The secure subsystem 204 may periodically update the stored information of the transaction processing subsystems 206.

In some alternative embodiments, during each transaction session, the secure subsystem 204 polls each transaction processing subsystem 206 in real-time to obtain the relevant information thereof, and uses the polled information to select a transaction processing subsystem 206 that best fits the client's request.

At step 282, the secure subsystem 204 generates a unique “fingerprint” for the transaction session by using data unknown to the client or client program 210. In some embodiments, the fingerprint for the transaction is generated by using the unique characteristics of the transaction session such as the connection, the transaction, the selected transaction processing subsystem 206, and any other metadata related to the transaction session. The data used for generating the fingerprint for a transaction may also depend on the payment type such as whether the payment is a one-lime payment or recurring payment.

For example, in one embodiment, the fingerprint for the transaction may be generated by using internal customer Globally Unique Identifiers (GUIDs) or Universally Unique Identifiers (UUIDs), specific payment gateway hash/customer IDs, generated GUIDs, session information, and/or the like.

For enhanced security, the content of the transaction and data related to the content of the transaction such as the payment information (for example the credit card number or the bank account number) are not used in generating the fingerprint. The generated fingerprint is stored in the secure subsystem 204 and associated with the transaction session. The generated fingerprint, as well as some or all data being used in generating the fingerprint, is never exposed to the client or client program 210,

The secure subsystem 204 then sends the information of the selected transaction processing subsystem 206 and the requested UI fragment 258 to the client program 210 (step 284). As described above, the UI fragment 258 sent to the client program 210 generally comprises UI components such as various text input fields for inputting payment information and one or more JavaScript Services that are injected into the client program 210 for executing on the client computing device 104 for completing the transaction.

At step 286, the client computing device 104 merges the received UI fragment with the webpage template to generate a payment page. The generated payment page is displayed on the client computing device 104, and the received transaction programs are executed for receiving user input and completing the transaction.

At step 288, the client uses the input fields on the displayed webpage to enter user data such as a credit card number, the cardholder's name, the CVV of the credit card, the expiration date of the credit card, and the like. After receiving the user data, the transaction programs encrypt the transaction data including the user data (step 290) and hashes the transaction (step 292). Then, the client computing device 104 sends the hashed transaction data to the selected transaction processing subsystem 206 (step 294). The selected transaction processing subsystem 2.06 receives the transaction data and use the received transaction data to complete the transaction (step 296). Then, the selected transaction processing subsystem 206 sends a transaction response such as a confirmation of transaction to the client computing device 104 (step 298).

At step 300, the client computing device 104 forwards the received transaction response to the merchant subsystem 202 for confirmation and logging. At step 302, the merchant subsystem 202 sends the transaction response to the secure subsystem 204 for validation. At step 304, the secure subsystem 204 uses the fingerprint associated with the transaction to validate the received transaction response. If the secure subsystem 204 confirms that the transaction response is valid (the “Yes” branch of step 306), the secure subsystem 204 notifies the merchant subsystem 202 and the merchant subsystem 202 process the valid transaction response such as logging a record of the transaction in the database 216 thereof. However, if the secure subsystem 204 determines that the transaction response is invalid (the “No” branch of step 306), the secure subsystem 204 then conducts fraud detection on the invalid transaction response (step 310). At this step, the secure subsystem 204 also notifies the selected transaction processing subsystem to revert or otherwise cancel the transaction, and notifies the merchant subsystem 202 that the transaction is invalid.

Although not shown in FIG. 6, if the transaction fails (for example, due to wrong credit card information, insufficient fund, and/or the like) at step 296, the selected transaction processing subsystem 206 will notify the client computing device 104 regarding the failure.

FIG. 6 shows the process of completing an online transaction in real-time in which the secure subsystem 204 does not directly interact with the transaction processing subsystem 206. However, as described above, the secure subsystem 204 may interact with the transaction processing subsystem 206 in other cases such as when processing batch payments and/or recurring payments.

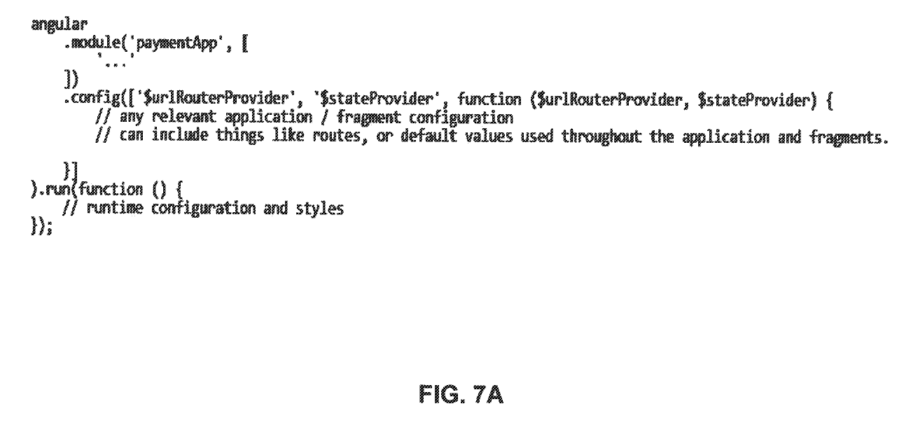

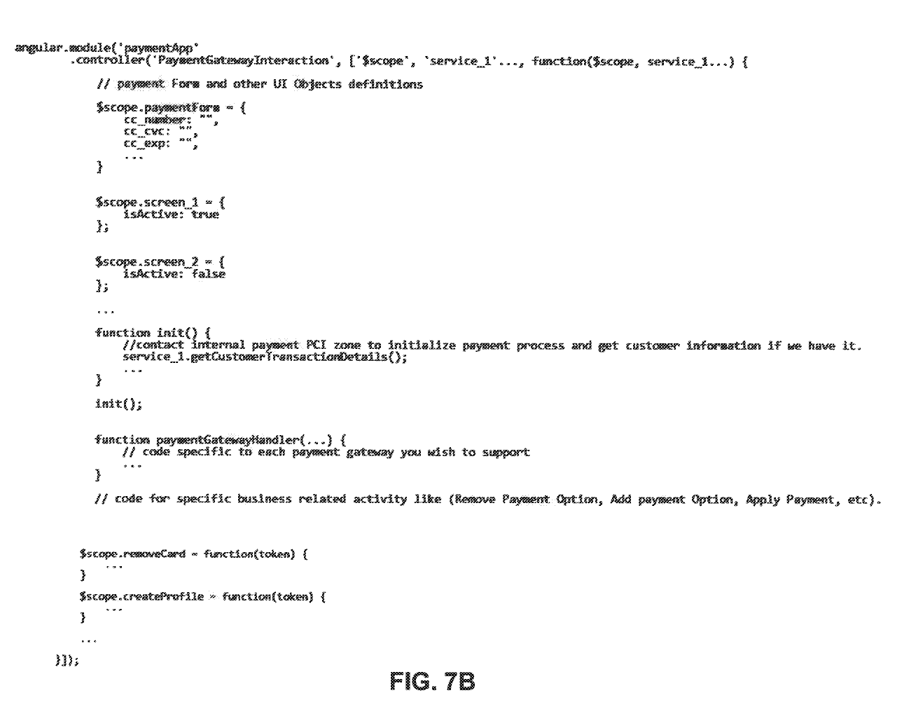

FIGS. 7A and 7B show an example of the runtime program of the UI fragment 258 implemented using JAVASCRIPT®. FIG. 7A shows a top-level JAVASCRIPT® runtime program for application initialization, and FIG. 7B shows a top-level JAVASCRIPT® fragment controller program for payment gateway extension.

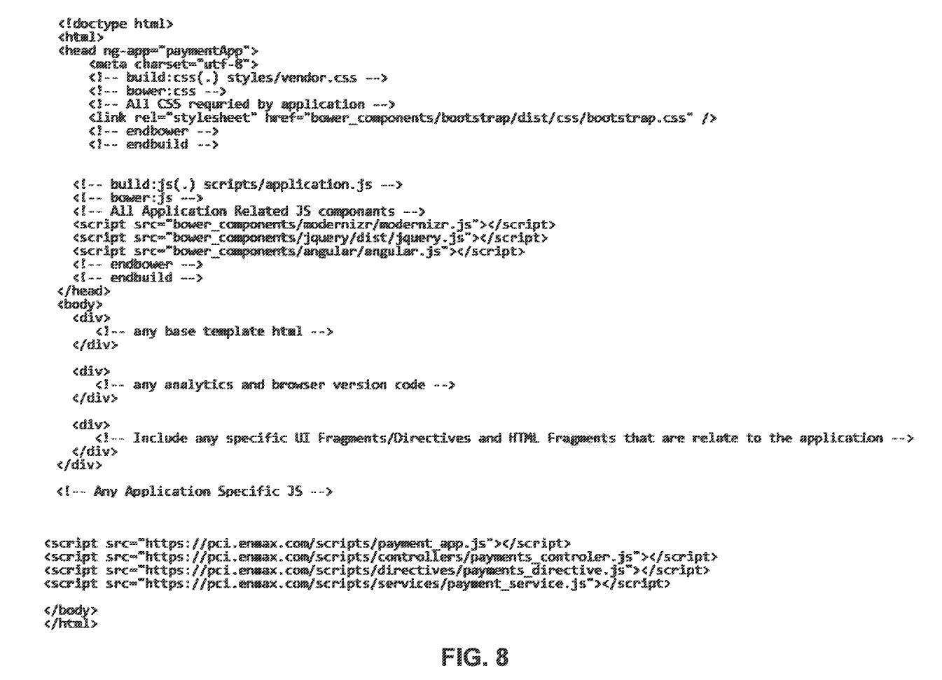

FIG. 8 shows an example of the UI component of the UI fragment 258 implemented using HTML.

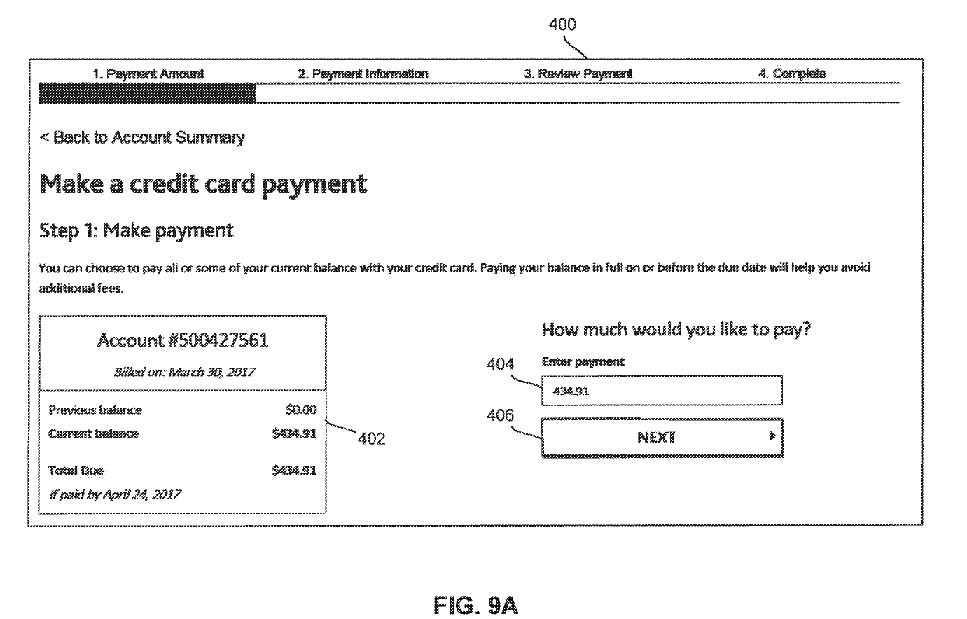

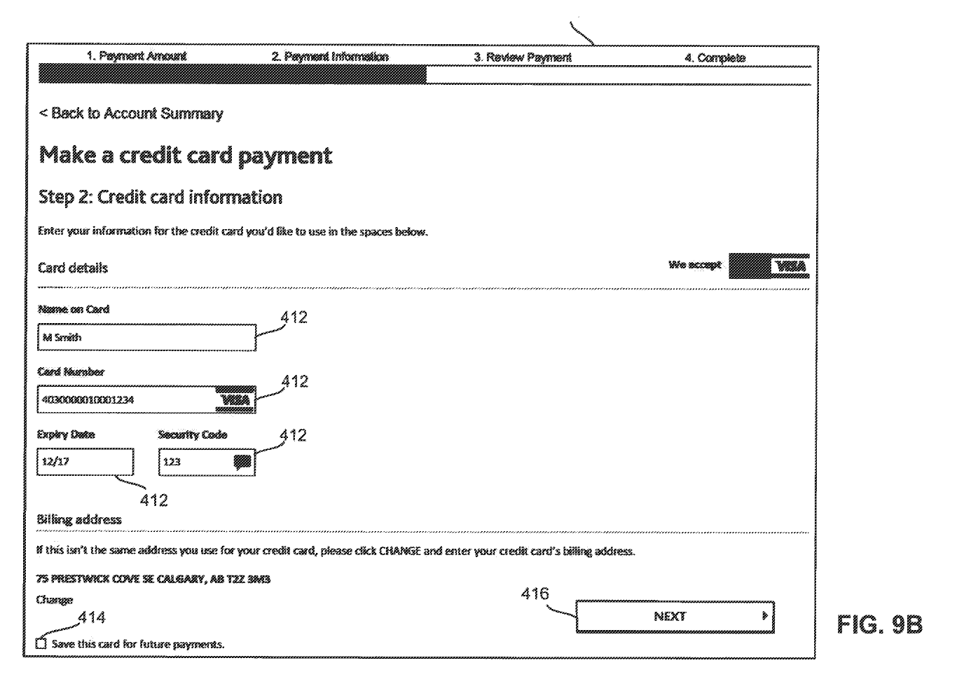

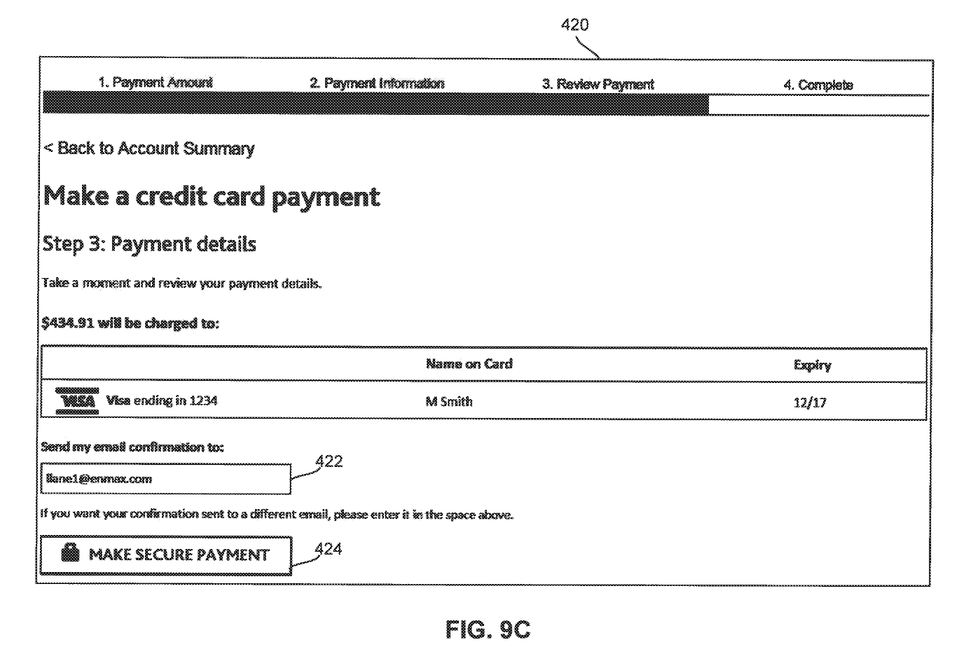

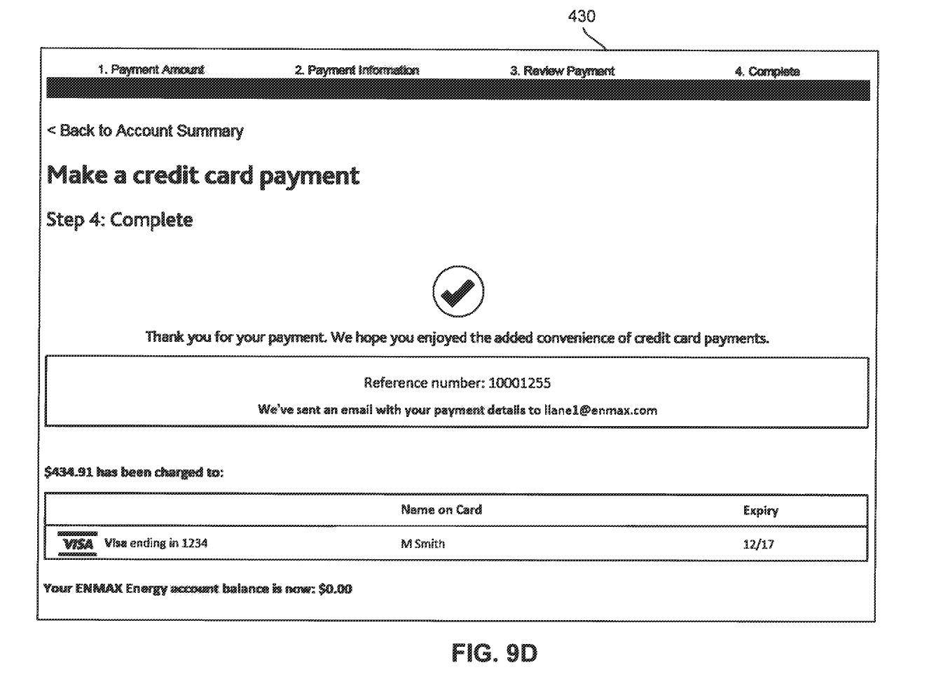

FIGS. 9A to 9D show an example of a payment process. In this example, a client (not shown) executes client program 210 such as a web browser program to visit a merchant system 202 to make a credit card payment for purchasing a service. Following the process 270 shown in FIG. 6, the merchant subsystem 202 sends a UI template to the client program 210. The secure subsystem 204 sends UI fragment 258 with a unique fingerprint to the client program 210. As a result, a payment webpage is formed and displayed on the client's computing device as shown in FIG. 9A. As shown, the payment webpage displays in a text field 402 the balance to be paid by the client, and presents a text input field 404 for the client to enter a payment amount. After entering the payment amount into the text input field 404, the client may click or press the “NEXT” button 406 to forward to a second payment webpage.

As shown in FIG. 9B, the second payment webpage 410 displays a plurality of text input fields 412 for the client to enter credit card information. The client may also check the box 414 to save the credit card information for future payments.

After entering the credit card information, the client may then press the “NEXT” button 416 to forward to a third payment webpage.

As shown in FIG. 9C, the third payment webpage 420 displays a summary of the payment to be proceed for the client to review. After confirming the correctness of the payment information, the client may enter an email address into the text input box 422 for receiving a confirmation email, and click the “MAKE SECURE PAYMENT” button 424 to make a payment transaction.

As described above, the UI fragment 258, or in particular the runtime program thereof encrypts the transaction data and directly collaborate with a selected transaction processing subsystem 206 to complete the transaction. After the transaction is completed, the client computing device display a fourth webpage 430 to display a confirmation of the completion of the payment transaction.

In the process shown in FIGS. 9A to 9D, the merchant subsystem 202 only provides a UI template. The UI fragment including UI components and runtime programs is sent from the secure subsystem 204 to the client program 210. The transaction related data such as the credit card information is communicated directly between the client computing device and the selected transaction processing subsystem 206, thereby bypassing the merchant subsystem 202 and the secure subsystem 204.

The online transaction system 100 exhibits significant advantages such as improved system safety and reliability, reduced system complexity and cost saving.

By separating the online transaction system 100 into a merchant subsystem 202 and a secure subsystem 204, the merchant subsystem 202 is thus completely isolated or otherwise excluded from accessing i.e. storing and processing, any transaction-related data. For example, the system-hosted transaction-related data is stored in the secure subsystem 204 and is provided to a client computing device 104, thereby bypassing the merchant subsystem 202. The user-provided transaction-related data is sent from a client computing device 104 directly to the selected transaction processing subsystem 206, thereby bypassing the merchant subsystem 202.

Consequently, the secure subsystem 204 is the only portion of the online transaction system 100 that is required to be PCI-compliant. Therefore, a merchant entity may choose to only invest in the secure subsystem 204 for PCI compliance (rather than making the entire system 100 PCI-compliant), thereby reducing the cost of deploying and operating the PCI-compliant online transaction system 100, and in particular, reducing the cost of upgrading an existing system to a PCI-compliant online transaction system 100.

The online transaction system 100 can inject a native UI fragment stored in the secure subsystem 204 into the web and/or mobile views on the client computing device 104, thereby providing a consistent look and feel experience throughout the entire transaction process.

Those skilled in the art will appreciate that various alternative embodiments are also readily available. For example, in some embodiments, the online transaction system 100 may only communicate with one transaction processing subsystem 206. Accordingly, the online transaction system 100 does not need the real-time service-provider selection mechanism (such as step 280 shown in FIG. 6).

In some alternative embodiments, the business support functions (module 254 shown in FIG. 5) are not resident in the merchant subsystem 202. Rather, the business support functions may be hosted in a separate subsystem. In some embodiments, the subsystem hosting the business support functions may be administrated and maintained by a separate entity.

In some alternative embodiments, the criteria and/or business rules for selecting a transaction processing subsystem 206 may be customized by, for example, an administrator of the online transaction system 100. In some other embodiments, the online transaction system 100 may ask the client to provide a set of service-provider selection criteria, and use the client-specified service-provider selection criteria to select a transaction processing subsystem 206.

In above embodiments, the merchant subsystem 202 sends non-transaction-related data such as a page template to a client computing device 104, and the secure subsystem 204 sends system-hosted transaction-related data such as one or more UI components and one or more client-side application programs to the client computing device 104. The secure subsystem 204 also sends the information of a selected transaction processing subsystem 206 to the client computing device 104.

The one or more client-side application programs then collect client-provided transaction-related data from the client, encrypt the collected transaction-related data, and send the encrypted transaction-related data to the selected transaction processing subsystem 206. Both the merchant subsystem 202 and the secure subsystem 204 are bypassed in the transmission of the encrypted transaction-related data from the client computing device 104 to the selected transaction processing subsystem 206.

In above embodiments, the one or more transaction processing subsystems 206 are not a part of the network system 100. In some alternative embodiments, the one or more transaction processing subsystems 206 are a part of the network system 100, but are managed by a separate group of users.

Those skilled in the art will appreciate that, in some embodiments, the above-described methods and process may be implemented as computer-executable code or instructions stored in any suitable non-transitory storage device comprising one or more storage media such as memory, hard drives, CD, DVD, flash drive, and/or the like.

Although embodiments have been described above with reference to the accompanying drawings, those of skill in the art will appreciate that variations and modifications may be made without departing from the scope thereof as defined by the appended claims.

What is claimed is:

1. A network system for completing a transaction session, the system comprising:
a merchant subsystem storing a first data set unrelated to said transaction; and
a secure subsystem storing a second data set related to said transaction;
wherein during the transaction, said network system acts for:
starting the transaction session;
sending at least said first data set from the merchant subsystem to a client computing device;
sending at least said second data set from the secure subsystem to the client computing device;
receiving at least a third data set related to said transaction; and
completing the transaction session using at least said third data set, such that the merchant subsystem is excluded from accessing said second and third data sets.

2. The network system of claim 1, wherein said completing the transaction session using at least said third data set comprises:
sending at least said third data set to a transaction processing subsystem for completing the transaction session.

3. The network system of claim 2, wherein said sending at least said third data set to the transaction processing subsystem comprises;
selecting the transaction processing subsystem from a plurality of transaction processing subsystems; and
sending at least said third data set to the selected transaction processing subsystem for completing the transaction session.

4. The network system of claim 1, wherein said first data set comprises a template unrelated to said transaction, said second data set comprises user-interface (UI) components and one or more client-side application programs, and said third data set comprises payment related data.

5. The network system of claim 4, wherein during the transaction, said network system further acts for executing the one or more client-side application programs on the client computing device to encrypt said third data sets and
wherein said sending at least said third data set to the transaction processing subsystem comprises sending at least said encrypted third data set to the transaction processing subsystem for completing the transaction session.

6. The network system of claim 1, wherein said secure subsystem is in compliance with one or more enhanced security standards.

7. The network system of claim 6, wherein said one or more enhanced security standards comprises Payment Card Industry (PCI) standards, and wherein said merchant subsystem is uncompliant with said PCI standards.

8. The network system of claim 1, wherein during said transaction, said secure subsystem generates a unique fingerprint for said transaction by using characteristics of the transaction session unrelated to the content of the transaction.

9. A method for completing a transaction session, the method comprising:
starting the transaction session;
sending at least a first data set from a merchant subsystem to a client computing device, said first data set unrelated to said transaction;
sending at least a second data set from a secure subsystem to the client computing device;
receiving at least a third data set related to said transaction; and
completing the transaction session using at least said third data set, such that the merchant subsystem is excluded from accessing said second and third data sets,

10. The method of claim 9, wherein said completing the transaction session using at least said third data set comprises:
sending at least said third data set to a transaction processing subsystem for completing the transaction session.

11. The method of claim 10, wherein said sending at least said third data set to the transaction processing subsystem comprises:
selecting the transaction processing subsystem from a plurality of transaction processing subsystems; and
sending at least said third data set to the selected transaction processing subsystem for completing the transaction session.

12. The method of claim 9, wherein said first data set comprises a template unrelated to said transaction, said second data set comprises UI components and one or more client-side application programs, and said third data set comprises payment related data.

13. The method of claim 9 further comprising displaying at least said received one or more UI components on the client computing device.

14. The method of claim 12 further comprising executing the one or more client-side application programs on the client computing device to encrypt said third data set; and
wherein said sending at least said third data set to the transaction processing subsystem comprises sending at least said encrypted third data set to the transaction processing subsystem for completing the transaction session.

15. The method of claim 9, wherein said secure subsystem is in compliance with one or more enhanced security standards.

16. The method of claim 15, wherein said one or more enhanced security standards comprises PCI standards, and wherein said merchant subsystem is uncompliant with said PCI standards.

17. The method of claim 9 further comprising generating a unique fingerprint for said transaction by using characteristics of the transaction session unrelated to the content of the transaction.

18. One or more non-transitory storage devices storing computer-executable instructions for completing a transaction session, wherein the instructions, when executed, cause a processor to perform actions comprising:
receiving a first data set from a merchant subsystem, said first data set unrelated to said transaction;
receiving at least one or more UI components and one or more client-side application programs from a secure subsystem;
displaying said one or more UI components;
collecting a transaction-related data set from a client;
executing said one or more client-side application programs to encrypt said collected transaction-related data set; and
sending the encrypted transaction-related data set to a transaction processing subsystem for completing the transaction session.

19. The one or more non-transitory storage devices of claim 18, wherein the instructions when executed, cause a processor to further perform actions comprising selecting the transaction processing subsystem from a plurality of transaction processing subsystems.

20. The one or more non-transitory storage device of claim 18, wherein the instructions when executed, cause a processor to further perform actions comprising generating a unique fingerprint for said transaction by using characteristics of the transaction session unrelated to the content of the transaction.
